(19) United States
(12) Patent Application Publication
(10) Pub. No.: US 2020/0128142 A1
(43) Pub. Date: Apr. 23, 2020

(54) IMAGE FORMING APPARATUS, VOICE RECOGNIZING DEVICE, AND NON-TRANSITORY RECORDING MEDIUM STORING COMPUTER READABLE PROGRAM

(71) Applicant: Konica Minolta, Inc., Tokyo (JP)

(72) Inventor: Tatsuya KAWANO, Tokyo (JP)

(73) Assignee: Konica Minolta, Inc., Tokyo (JP)

(21) Appl. No.: 16/594,319

(22) Filed: Oct. 7, 2019

(30) Foreign Application Priority Data
Oct. 18, 2018 (JP) 2018-196340

(51) Int. Cl. H04N 1/00; G10L 21/0208; G10L 15/22

(52) U.S. Cl. CPC H04N 1/00403; H04N 1/00994; G10L 2015/223; G10L 15/22; G10L 21/0208

(57) ABSTRACT

A conventional image forming apparatus could not accurately recognize a voice job execution instruction input during execution of the job.

An image forming apparatus includes a control section that executes an input job, a noise pattern determination section that determines a noise pattern corresponding to an operation sound generated in the image forming apparatus based on an execution state of the job to be executed by the control section, a denoising section that eliminates a noise corresponding to the noise pattern from sound data to be input from an input section for collecting sounds based on the noise pattern data determined by the noise pattern determination section in accordance with a type of the job under execution by the control section, and a voice recognizing section that recognizes an execution instruction of the job from the sound data having the noise eliminated.

### CROSS-REFERENCE TO RELATED APPLICATIONS

The entire disclosure of Japanese Patent Application No. 2018-196340, filed on Oct. 18, 2018, is incorporated herein by reference in its entirety.

### BACKGROUND

### Technological Field

The present invention relates to an image forming apparatus, a voice recognizing device, and a non-transitory recording medium storing a computer readable program.

### Description of the Related Art

Generally, an image forming apparatus that performs multiple functions, for example, faxing, copying, and printing such as a digital multifunctional machine is configured to receive execution instructions of jobs or various kinds of processing through user's touching of an operation panel. There has been introduced the image forming apparatus configured to receive the execution instruction by inputting voice (hereinafter referred to as “voice execution instruction”) to the voice input device besides the execution instruction via the operation panel. When the received voice spoken by the user is recognized to contain the phrase indicating the process to be executable by the image forming apparatus, the image forming apparatus extracts such phrase from the voice input to the voice input device. The image forming apparatus then identifies the user's execution instruction from the sound data corresponding to the extracted phrase, based on which the job is executed.

The user is allowed to input the execution instruction to the image forming apparatus using the voice input device so as to operate the image forming apparatus in a touchless manner. The user is not required to perform complicated operations to the image forming apparatus, thus enhancing operability such as “user friendliness” and “comprehensibility”. It is therefore possible to facilitate efforts toward the universal design that releases dissatisfactions felt by users such as “user unfriendliness” and “incomprehensibility” regardless of physical ability, age, physical constitution and the like of the user.

For example, a microphone is employed as the voice input device. Normally, the microphone is built in the main body of the image forming apparatus, or disposed adjacent to the image forming apparatus. When inputting the voice execution instruction during execution of the job, there may be the case where an operation sound is generated by a movable part of the image forming apparatus in association with execution of the job. Such sound is then mixed with the user's voice, and collectively input to the microphone. The operation sound serving as noise may obstruct the image forming apparatus from analyzing the sound data, thus failing to accurately recognize the user's voice. As a result, the image forming apparatus cannot identify the user's execution instruction, failing to execute the job based on the instruction.

Japanese Patent Laid-Open Nos. 2010-136335 and 2004-163458 (Patent Literatures 1 and 2) disclose a technology known for preventing mixture of the operation sound with the user's voice from being input to the microphone.

Patent Literature 1 discloses that in response to an input of the user's voice with respect to an operation, the image forming apparatus temporarily stops the operation of the associated device to avoid lowering of the voice recognizing efficiency owing to the operation sound generated while the device is operated.

Patent Literature 2 discloses the voice recognizing device that executes the voice recognizing process selectively in accordance with the indoor noise cancelling mode and the in-vehicle noise cancelling mode based on the determination whether the voice recognizing device is used indoors or in the vehicle.

### CITATION LIST

### Patent Literature

[Patent Literature 1] Japanese Patent Laid-Open No. 2010-136335
[Patent Literature 2] Japanese Patent Laid-Open No. 2004-163458

### SUMMARY

The method of eliminating noise to be mixedly input to the microphone may be implemented by predicting the noise to be generated based on the sound input in a time-series order so that the input noise as predicted is eliminated. This method is effective only for eliminating the noise that is steadily generated like the environmental noise. The method cannot eliminate the sound to be generated in association with the operation of the image forming apparatus, for example, the one that irregularly changes its volume and sound quality. The “irregular noise” denotes the unexpectedly generated sound, for example, the compound of various operation sounds of the respective components installed in the image forming apparatus, and the abnormal sound generated when abnormality occurs.

In Patent Literature 1, while the user's voice is input for the operation, the device is temporarily stopped so that the job execution is suspended until the temporarily stopped state is released. As a result, the job execution is delayed, making the user feel like that the operability of the image forming apparatus is deteriorated. It is difficult for the technology disclosed in the document to determine whether or not the voice has been input in the environment especially at high noise level (for example, large noise sound).

In Patent Literature 2, the voice recognizing device switches the noise cancelling mode in accordance with the environment where the voice recognizing device is operated. The disclosed technology is effective only for reducing the noise that is steadily generated in the environment for operating the voice recognizing devices, and fails to eliminate the noise, that is, the sound that changes its volume and sound quality unexpectedly.

The present invention has been made to accurately recognize the voice job execution instruction even in the environment where the operation sounds are generated during execution of the job.

To achieve the abovementioned object, according to an aspect of the present invention, an image forming apparatus reflecting one aspect of the present invention includes a control section that executes an input job, a noise pattern determination section that determines a noise pattern corresponding to an operation sound generated in the image forming apparatus based on an execution state of the job to be executed by the control section, a denoising section that eliminates a noise corresponding to the noise pattern from sound data to be input from an input section for collecting sounds based on the noise pattern data determined by the noise pattern determination section in accordance with a type of the job under execution by the control section, and a voice recognizing section that recognizes an execution instruction of the job from the sound data having the noise eliminated.

It is to be noted that the above described image forming apparatus is an embodiment of the present invention. Likewise the image forming apparatus, the voice recognizing device, and the non-transitory recording medium storing a computer readable program may be configured to reflect an aspect of the present invention.

### BRIEF DESCRIPTION OF THE DRAWINGS

The advantages and features provided by an embodiment of the invention will become more fully understood from the detailed description given hereinbelow and the appended drawings which are given by way of illustration only, and thus are not intended as a definition of the limits of the present invention:

FIG. 1 is a block diagram showing an exemplary structure of an image forming apparatus according to an embodiment of the present invention;

FIG. 2 is a function block diagram showing an exemplary structure of an essential part of the image forming apparatus according to the embodiment of the present invention;

FIG. 3 is a function block diagram showing functions of the image forming apparatus to be performed in response to a voice job execution instruction according to the embodiment of the present invention;

FIG. 4 is a flowchart showing an exemplary process to be executed in a noise pattern determination section according to the embodiment of the present invention;

FIG. 5 is a flowchart showing an exemplary process to be executed in response to the voice job execution instruction until start of the job execution according to the embodiment of the present invention; and

FIG. 6 is explanatory views showing an example of a method of eliminating noise from sound data.

### DETAILED DESCRIPTION OF EMBODIMENTS

An embodiment according to the present invention will be described referring to the drawings. However, the scope of the invention is not limited to the disclosed embodiments. In the specification and the drawings, components with substantially the same functions or structures will be designated with the same reference signs so as to omit repetitive explanations.

### EMBODIMENT

### <Exemplary Structure of Image Forming Apparatus>

An exemplary structure of an image forming apparatus 1 according to a present embodiment will be described.

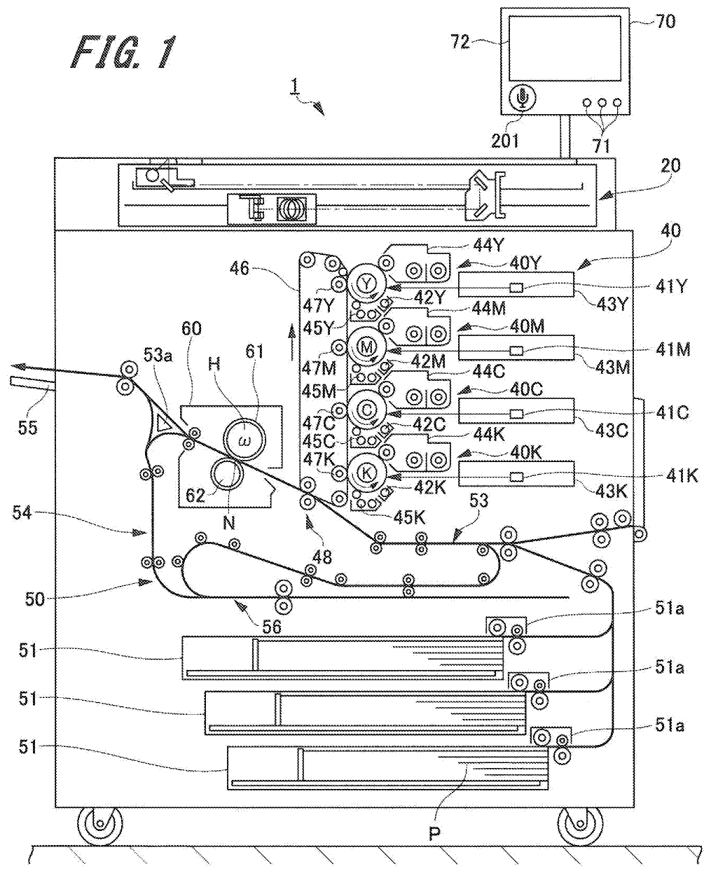

FIG. 1 illustrates components or those relevant thereto necessary for explaining the present invention. However, the components of the image forming apparatus 1 are not limited to those as shown in FIG. 1.

An image forming apparatus of electrophotographic type, for example, a copying machine is exemplified as the image forming apparatus 1. The image forming apparatus 1 as shown in FIG. 1 is so called a color image forming apparatus of tandem type, and configured to have a plurality of photoreceptors vertically arranged to face a single intermediate transfer belt so as to form a full-color image.

The image forming apparatus 1 includes an image reading section 20, an image forming section 40, a sheet carrier section 50, a fixing device 60, and an operation display section 70.

The image reading section 20 allows an optical system of a scanning exposure device to conduct scanning exposure to an image on the document so that the resultant reflected light is read by a line image sensor for acquiring an image signal.

The image forming section 40 forms an image on a sheet P (an example of recording materials). The image forming section 40 is constituted by an image forming section 40Y for forming a yellow (Y) image, an image forming section 40M for forming a magenta (M) image, an image forming section 40C for forming a cyan (C) image, and an image forming section 40K for forming a black (K) image. The image forming sections 40Y, 40M, 40C, 40K allow a toner image to be transferred onto a resin sheet as one of the recording materials.

The image forming section 40Y includes a photoreceptor drum Y having a charging unit 42Y in its periphery, an optical writing member 43Y having a laser diode 41Y, a developing device 44Y, and a drum cleaner 45Y. Likewise, the image forming sections 40M, 40C, 40K include a photoreceptor drum M having a charging unit 42M in its periphery, a photoreceptor drum C having a charging unit 42C in its periphery, a photoreceptor drum K having a charging unit 42K in its periphery, an optical writing member 43M having a laser diode 41M, an optical writing member 43C having a laser diode 41C, an optical writing member 43K having a laser diode 41K, developing devices 44M, 44C, 44K, and drum cleaners 45M, 45C, 45K, respectively.

The photoreceptor drum Y has its surface uniformly charged with the charging unit 42Y, and a latent image is formed by scanning exposure from the laser diode 41Y of the optical writing member 43Y. The developing device 44Y makes the latent image on the photoreceptor drum Y apparent through development with toner. This makes it possible to form an image corresponding to yellow on the photoreceptor drum Y.

Likewise, the photoreceptor drum M has its surface uniformly charged with the charging unit 42M, and a latent image is formed by scanning exposure from the laser diode 41M of the optical writing member 43M. The developing device 44M makes the latent image on the photoreceptor drum M apparent through development with toner. This makes it possible to form an image corresponding to magenta on the photoreceptor drum M.

The photoreceptor drum C has its surface uniformly charged with the charging unit 42C, and a latent image is formed by scanning exposure from the laser diode 41C of the optical writing member 43C. The developing device 44C makes the latent image on the photoreceptor drum C apparent through development with toner. This makes it possible to form an image corresponding to cyan on the photoreceptor drum C.

The photoreceptor drum K has its surface uniformly charged with the charging unit 42K and a latent image is formed by scanning exposure from the laser diode 41K of the optical writing member 43K. The developing device 44K makes the latent image on the photoreceptor drum K apparent through development with toner. This makes it possible to form an image corresponding to black on the photoreceptor drum K.

Primary transfer rollers 47Y, 47M, 47C, 47K are operated to perform primary transfer of images formed on the photoreceptor drums Y, M, C, K, respectively to predetermined positions on an intermediate transfer belt 46 as a belt-like intermediate transfer body successively. The images of transferred colors on the intermediate transfer belt 46 are further secondarily transferred by a secondary transfer section 48 onto the sheet P to be carried by the sheet carrier section 50 at a predetermined timing.

The sheet carrier section 50 includes a plurality of sheet feed devices 51, each storing the sheets P, and sheet feeders 51a each configured to supply the sheet P stored in the sheet feed device 51 while being reeled out. The sheet carrier section 50 includes a main carrier path 53 through which the sheet P fed from the sheet feed device 51 is carried, a reversing carrier path 54 that is branched from the main carrier path 53 downstream from the fixing device 60, and reverses the sheet P upside down, and a sheet discharge tray 55 from which the sheet P is discharged.

The sheet carrier section 50 includes a switching gate 53a disposed at a position where the reversing carrier path 54 is branched from the main carrier path 53. In the image forming apparatus 1, the image is formed on an upwardly directed surface (first surface) of the sheet P that has been carried with the main carrier path 53 while passing the secondary transfer section 48 and the fixing device 60. In the case of forming images on both surfaces of the sheet P, the sheet P with the image formed on the upwardly directed surface is carried from the main carrier path 53 to the reversing carrier path 54. The sheet P is then reversed on a sheet reversing carrier path 56 of the reversing carrier path 54 so that the image formed surface (first surface) of the sheet P is directed downward. The sheet P is carried to the main carrier path 53. This makes it possible to form an image on the other upwardly directed surface (second surface) of the reversed sheet P.

The fixing device 60 includes a fixing roller 61 and a pressurizing roller 62 for fixing the toner image formed by the image forming section 40 on the sheet P. The fixing device 60 is disposed downstream from the intermediate transfer belt 46. The fixing device 60 carries the sheet P using a tightly contacted pair of the fixing roller 61 and the pressurizing roller 62, and executes the process for fixing the secondarily transferred toner image onto the sheet P. The fixing roller 61 and the pressurizing roller 62 may be used as fixing members. A heater H is provided inside the fixing roller 61. The heater H heats the surface of the fixing roller 61 so that the heat is transmitted to the sheet P that passes a fixing nip N between the fixing roller 61 and the pressurizing roller 62. The heated fixing roller 61 rotates with respect to its axis to transfer the heat to the sheet P while passing through the fixing nip N. As the sheet P is heated, the toner image on the sheet P melts for fixation thereon.

The operation display section 70 includes an operation section 71, a display section 72, and a microphone 201. The operation section 71 is constituted by a plurality of operation buttons for receiving a user's operation. The display section 72 is constituted by a touch panel display having a touch panel and a display for showing various screens such as a guide screen to the user. The display section 72 displays images of operation buttons to be touched, and receives the user's touching operation. The microphone 201 collects sounds including the user's voice (including voice job execution instruction), operation sound generated in the image forming apparatus 1, and the environmental sound.

### <Exemplary Structure of Essential Part in Image Forming Apparatus>

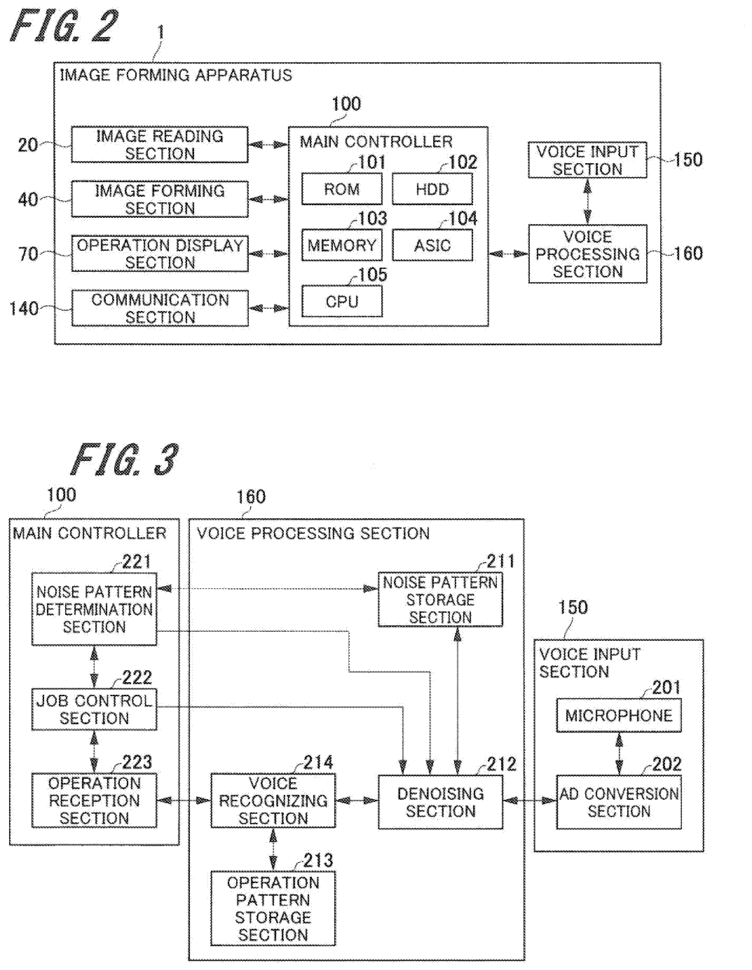

FIG. 2 is a function block diagram illustrating an exemplary structure of an essential part in the image forming apparatus 1.

The image forming apparatus 1 includes a main controller 100, the image reading section 20, the image forming section 40, the operation display section 70, a communication section 140, a voice input section 150 (an example of input section), and a voice processing section 160. Those function sections are mutually connected with one another.

The main controller 100 executes jobs such as an image reading (scanning) process and an image forming (printing) process, and various types of processing (setting change) based on the execution instruction through touching to the operation display section 70, or the execution instruction through input from a not shown PC (Personal Computer) terminal, a print controller or the like via the communication section 140. In the explanation to be described below, the “jobs and various types of processing” will be collectively referred to as a “job”.

In response to an input of the voice from the user for instructing execution of the job through the voice input section 150, the main controller 100 executes the job based on the execution instruction recognized by the voice processing section 160.

Detailed explanations of the image reading section 20, the image forming section 40 and the operation display section 70 will be omitted in order to avoid repetitive explanations with respect to FIG. 1.

The communication section 140 is an interface that is constituted by an NIC (Network Interface Card), a modem and the like, and connected to a not shown network such as LAN outside the image forming apparatus 1. The communication section 140 establishes the connection with the PC terminals, for example, to execute transmission and reception of various kinds of data.

The voice input section 150 collects sounds in the periphery of the area where the voice input section 150 is disposed. The voice input section 150 converts the input sound into sound data of a digital signal, and outputs the signal to the voice processing section 160 (see FIG. 2 to be described below). The sound to be input to the voice input section 150 includes operation sounds generated in the image forming apparatus 1 that executes the job, and the user's voice spoken in front of the voice input section 150. The operation sound may vary depending on the job type to be executed by the image forming apparatus 1.

The voice processing section 160 recognizes the voice by eliminating the noise corresponding to the noise pattern from the sound data of the digital signal that has been input from the voice input section 150 so as to identify the job in accordance with the voice execution instruction input by the user. The voice processing section 160 will be described in detail later referring to FIG. 3.

The main controller 100 is a hardware serving as a computer to be used for the image forming apparatus 1. The main controller 100 includes a CPU (Central Processing Unit) 105, a ROM (Read Only Memory) 101, and a memory 103. The main controller 100 further includes a HDD (Hard Disk Drive) 102, and an ASIC (Application Specific Integrated Circuit) 104. The respective sections of the main controller 100 are connected via a not shown bus.

The CPU 105 reads the program code of the software that implements the respective functions according to the embodiment from the ROM 101, and executes the program. A noise pattern determination section 221, a job control section 222, and an operation reception section 223 to be described later referring to FIG. 3 constitute some part of functions to be executed by the CPU 105.

The ROM 101 is used as a non-volatile memory, for example, and stores the program and data required for operating the CPU 105.

The memory 103 is used as a volatile memory, for example, and temporarily stores variables and parameters generated in the middle of the arithmetic processing necessary for the respective processing to be executed by the CPU 105.

The ASIC 104 executes some of processing to be executed in the image forming apparatus 1 for the purpose of reducing the processing load to the CPU 105, and performing various complicated processing functions efficiently and smoothly. For example, the ASIC executes the process of compressing the image data input to the image forming apparatus 1 so as to be stored in the memory 103, and the process of expanding the compressed image data so as to be printed.

The ASIC 104 compresses the sound data that have been input to the voice input section 150 in accordance with a predetermined sound compression scheme (for example, MP3 (MPEG Audio Layer 3)), and further expands the compressed sound data in accordance with a predetermined sound extension scheme.

The HDD 102 is used as a non-volatile storage, for example, and stores the program that allows the CPU 105 to control the respective sections, OS, the program of the controller or the like, and data. The program and the data to be stored in the HDD 102 are partially stored in the ROM 101. The HDD 102 and the ROM 101 are used as a non-transitory recording medium storing a computer readable program to be executed by the CPU 105. Accordingly, the program is stored in the HDD 102 permanently. It is possible to employ an SSD (Solid State Drive), a CD-ROM, and a DVD-ROM as the non-transitory recording medium storing a computer readable program to be executed by the main controller 100 without being limited to the HDD.

The image forming apparatus 1 according to the embodiment is capable of executing the job based on the execution instruction from the operation display section 70 and the communication section 140. The image forming apparatus 1 is also capable of executing the job in response to the voice execution instruction from the user.

### <Exemplary Voice Execution Instruction to Image Forming Apparatus>

FIG. 3 is a function block diagram showing functions of the image forming apparatus in response to the voice execution instruction.

The voice input section 150 includes the microphone 201 and an AD conversion section (ADC: Analog to Digital Converter) 202.

The voice processing section 160 includes a noise pattern storage section 211, a denoising section 212, an operation pattern storage section 213, and a voice recognizing section 214. The noise pattern storage section 211 is shown as an example of the storage section.

The main controller 100 includes the noise pattern determination section 221, the job control section 222, and the operation reception section 223.

The microphone 201 collects sounds in the periphery thereof, and outputs the collected sounds as data of an analog signal to the AD conversion section 202. For example, the microphone 201 is disposed adjacent to the image forming apparatus 1, and collects the user's voice. The voice contains the phrase corresponding to the execution instruction of the user instructing the image forming apparatus 1 to execute the job. If the user inputs the voice execution instruction while the image forming apparatus 1 is executing the job, the microphone 201 collects the user's voice execution instruction as well as the operation sound generated by the movable parts operated in the image forming apparatus 1.

The AD conversion section 202 converts the sound data of the analog signal collected by the microphone 201 into the sound data of the digital signal. If the user inputs the voice execution instruction during execution of the job, the resultant sound data contain the user's voice and the operation sound mixed therewith. The operation sound is the noise mixed with the voice data.

When the operation sound is mixed with the voice data, the image forming apparatus 1 fails to accurately recognize only the user's voice from the sound data. It is therefore difficult to execute the job based on the voice execution instruction. In order to allow the image forming apparatus 1 to recognize the voice execution instruction accurately, the operation sound as the noise has to be removed from the sound data. The operation sound tends to be generated regularly depending on the job type due to configuration of the image forming apparatus 1. When the single job is to be executed, the operation sound generated in the image forming apparatus 1 may be predicted. The AD conversion section 202 outputs the sound data of the converted digital signal to the denoising section 212 of the voice processing section 160.

If there is the job under execution by the job control section 222 of the main controller 100, the denoising section 212 eliminates the noise corresponding to the noise pattern from the sound data based on the data of the noise pattern determined by the noise pattern determination section 221 in accordance with type of the job under execution. The denoising section 212 executes the noise elimination in real time upon input of the sound data of the digital signal from the AD conversion section 202. In order to execute the denoising process, the denoising section 212 acquires the job information (for example, print setting) relating to the job under execution. This makes it possible to accurately acquire the noise pattern data from the noise pattern storage section 211.

The denoising section 212 outputs the sound data having the noise corresponding to the noise pattern eliminated (hereinafter referred to as “denoised sound data”) to the voice recognizing section 214.

If there is no job under execution when the sound data of the digital signal are received from the AD conversion section 202, the denoising section 212 outputs the sound data directly to the voice recognizing section 214.

The noise pattern storage section 211 preliminarily stores noise pattern data corresponding to the operation sound generated in accordance with the job type to be executed by the job control section 222 in the image forming apparatus 1 (associated device). The noise pattern storage section 211 also newly stores the noise pattern data to be generated in the noise pattern determination section 221. The denoising section 212 acquires the noise pattern data determined by the noise pattern determination section 221 from the noise pattern storage section 211 in accordance with the type of job under execution by the job control section 222, and execution states of the jobs, and ensures to eliminate the noise pattern data from the sound data.

The operation pattern storage section 213 preliminarily stores the pattern of the sound data (to be referred to as “operation pattern data”) corresponding to the execution instruction input by the user to instruct the image forming apparatus 1 to execute the job. The user may specify the operation pattern data for shortening execution of the job so as to allow additional registration of the operation pattern data to the operation pattern storage section 213. For example, the operation for executing both the scanning process and the printing process may be preliminarily set to “Operation No. 1”. Assuming that the user instructs the image forming apparatus 1 to execute both the scanning process and the printing process to the document placed on the image reading section 20, the user will input the voice phrase “operation No. 1”. The user allows the image forming apparatus 1 to execute a plurality of jobs (printing process after execution of the scanning process) by speaking the simple phrase.

The voice recognizing section 214 compares the denoised sound data with the operation pattern data acquired from the operation pattern storage section 213. If the operation pattern data that match the denoised sound data exist, the voice recognizing section 214 recognizes the job execution instruction (recognizing voice), and outputs the execution instruction to the operation reception section 223 based on the operation pattern data. As described above, the voice recognizing section 214 is allowed to recognize the job execution instruction through the voice input section 150 from the denoised sound data.

The operation reception section 223 inputs the job execution instruction that has been input from the voice recognizing section 214 to the job control section 222. An input of the job execution instruction to be received by the operation reception section 223 will be referred to as a “reception of operation”.

Based on the execution instruction input from the operation reception section 223, the job control section 222 executes the job input to the image forming apparatus 1. The information about the job under execution by the job control section 222, or the information about the execution state of the job under execution will be suitably transmitted to the noise pattern determination section 221 and the denoising section 212.

The noise pattern determination section 221 acquires the information about the execution state of the job to be executed from the job control section 222, and determines the noise pattern corresponding to the operation sound generated in accordance with the execution state of the job to be executed by the job control section 222 in the image forming apparatus 1. The job execution state is kept unchanged in the period from the start to the end of executing the job.

Assuming that the job execution state that is expected to be continued is changed, there are no noise pattern data corresponding to the job operation sound stored in the noise pattern storage section 211 because the noise pattern data are generated based on the operation sound to be generated in the job execution state that is considered to be continued from the start to the end of executing the job. If the voice is input to the microphone 201 after the execution state of the job under execution changes, the denoising section 212 may fail to accurately eliminate the noise from the sound data.

The noise pattern determination section 221 newly generates noise pattern data based on the change in the execution state of the job under execution by the job control section 222. For example, in the period for which multiple jobs are executed in parallel, if there is the remaining job to be executed in advance, or the job to be newly executed, the corresponding job information is acquired from the job control section 222.

The job information includes the types and the execution start times of the jobs to be executed in parallel. Based on the acquired job information, the noise pattern determination section 221 newly generates the noise pattern data corresponding to the operation sound to be generated in association with the job execution after the change in the job execution state. If the jobs of different types are executed by the job control section 222 in parallel, the noise pattern determination section 221 is capable of generating new noise pattern data by combining noise pattern data determined from the respective jobs. The noise pattern determination section 221 stores the newly generated noise pattern data in the noise pattern storage section 211.

The denoising section 212 eliminates the noise corresponding to the new noise pattern from the sound data based on the noise pattern data newly generated by the noise pattern determination section 221. Even in the case where the voice containing the new execution instruction is input to the microphone 201 after the change in the job execution state, the denoising section 212 is capable of eliminating the noise from the sound data.

In the case that the voice processing section 160 does not include the noise pattern storage section 211, the noise pattern determination section 221 may be configured to send the noise pattern data determined based on the job execution state, and the newly generated noise pattern data directly to the denoising section 212. The denoising section 212 is allowed to eliminate the noise from the sound data using the noise pattern data acquired from the noise pattern determination section 221 with no need of referring to data in the noise pattern storage section 211.

The change in the job execution state is expected to occur in any of the following cases in which: the job execution is instructed; in the middle of executing the job, another job is to be executed in parallel; one of the jobs which have been executed in parallel is to be terminated; execution of all jobs is to be terminated; abnormality occurs in the job under execution; and the abnormality is eliminated.

For example, the noise pattern storage section 211 stores the noise pattern data corresponding to the operation sounds generated upon execution of the scanning process and the printing process separately. It is assumed that the printing process is started in the middle of the scanning process, and the scanning process is terminated earlier. In the above-described case, the scanning process and the printing process are executed partially in parallel. The operation sound to be generated in the period from the start of the printing process to the end of the scanning process may be constituted as the mixture of the operation sounds generated by the respective movable parts in association with the scanning process and the printing process. The noise pattern determination section 221 is required to newly generate the noise pattern data. In each timing before the start of the printing process, and after the end of the scanning process, the operation sound is generated corresponding to the single job. Therefore, the noise pattern data are stored in the noise pattern storage section 211.

As the timing when the printing process is executed parallel to the scanning process under execution varies each time, the noise pattern determination section 221 is required to generate the new noise pattern data in each timing. The newly generated noise pattern data may be kept stored in the noise pattern storage section 211. However, such data may be deleted after termination of executing the job.

The change in the job execution state may occur in the case of abnormality such as jamming of passing sheet, and running out of sheet, and elimination of the abnormality during formation of the image.

For example, jamming of passing sheet or running out of sheet may cause biting of the gear into the sheet P, or stuffing of the sheet P without being discharged, leading to abnormal operation sounds. In this case, the noise pattern determination section 221 is required to generate the new noise pattern data. In most cases, after solving the jamming of the passing sheet and running out of the sheet, the subsequent process may be normally executed. Accordingly, the existing noise pattern data stored in the noise pattern storage section 211 may be used.

### <Exemplary Processing in Noise Pattern Determination Section>

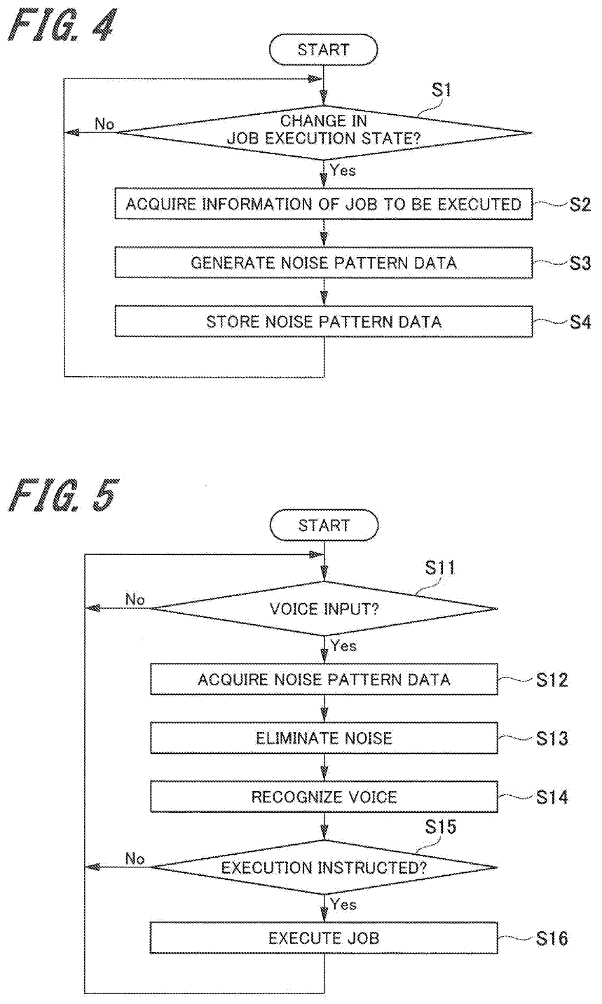

FIG. 4 is a flowchart showing an example of the process to be executed in the noise pattern determination section 221.

The noise pattern determination section 221 determines whether or not the execution state of the job under execution by the job control section 222 has been changed (S1).

If it is determined that the execution state of the job under execution has not been changed (No in S1), the noise pattern determination section 221 returns to step S1 where it is determined again as to the change in the execution state of the job under execution. In other words, if there is no change in the execution state of the job under execution, the noise pattern determination section 221 repeatedly executes step S1.

If it is determined that the execution state of the job under execution has been changed (Yes in S1), the noise pattern determination section 221 acquires job information about the corresponding job from the job control section 222 (S2). The corresponding job refers to the remaining job to be subsequently executed, and the job to be newly executed after the change in the execution state of the job under execution.

Based on the job information acquired from the job control section 222, the noise pattern determination section 221 newly generates the noise pattern data corresponding to the operation sound that is generated in the corresponding job to be executed after the change in the job execution state (S3).

Upon generation of the new noise pattern data, the noise pattern determination section 221 refers to the noise pattern data corresponding to the job types, which are preliminarily stored in the noise pattern storage section 211. If a plurality of jobs of different types are executed in parallel, the noise pattern determination section 221 generates new noise pattern data by combining the noise patterns of the jobs of different types to be executed.

The noise pattern determination section 221 stores the newly generated noise pattern data in the noise pattern storage section 211 (S4).

The noise pattern determination section 221 then returns the process to step S1 where it is determined as to the change in the execution state of the job under execution.

<Exemplary Processing from Voice Execution Instruction to Job Execution>

FIG. 5 is a flowchart showing an example of the process from the voice execution instruction to the job execution.

The denoising section 212 determines whether or not the voice has been input, that is, the sound data of the digital signal have been input from the AD conversion section 202 of the voice input section 150 (S11).

If it is determined that the sound data of the digital signal have not been input (No in S11), the denoising section 212 returns the process to step S11 where it is determined again whether the sound data of the digital signal have been input. If the sound data of the digital signal have not been input, the denoising section 212 repeatedly executes the process in step S11.

If it is determined that the sound data of the digital signal have been input (Yes in S11), the denoising section 212 acquires the noise pattern data corresponding to the operation sound that is generated by the operated movable parts of the image forming apparatus 1 in association with execution of the job from the noise pattern storage section 211 (S12). The denoising section 212 may be configured to acquire the noise pattern data determined by the noise pattern determination section 221 directly therefrom.

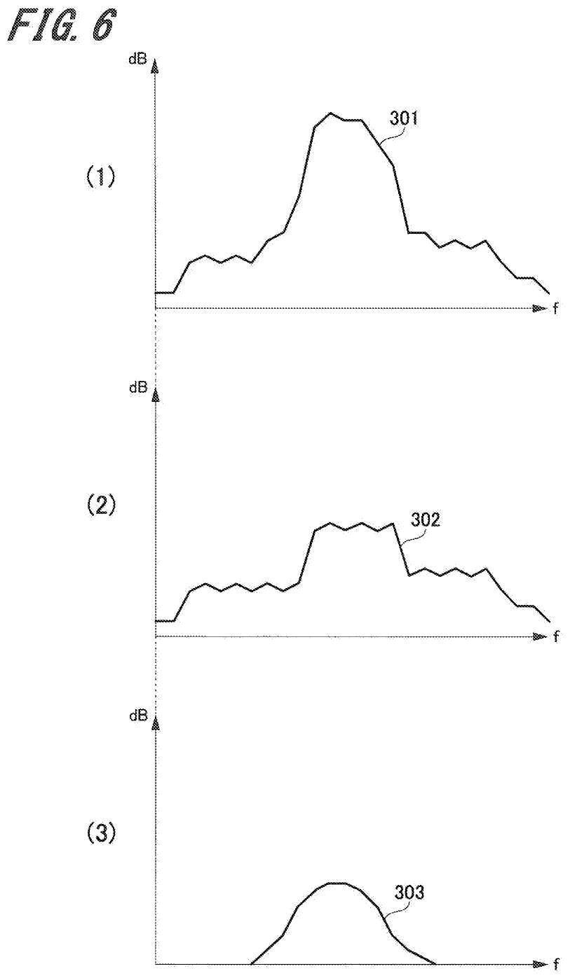

Based on the acquired noise pattern data, the denoising section 212 eliminates the noise contained in the sound data (S13). The denoising method to be implemented by the denoising section 212 will be described later referring to FIG. 6. The denoising section 212 then outputs the sound data having the noise pattern data eliminated (denoised sound data) to the voice recognizing section 214.

The voice recognizing section 214 executes the voice recognition of the input denoised sound data (S14). At this time, the voice recognizing section 214 compares the input denoised sound data with the operation pattern data acquired from the operation pattern storage section 213. As has been already described, the operation pattern storage section 213 preliminarily stores the sound data patterns (operation pattern data) corresponding to the user's execution instruction causing the image forming apparatus 1 to execute the job.

The voice recognizing section 214 determines whether or not the execution instruction is contained in the denoised sound data (S15). If it is determined that the execution instruction is not contained in the denoised sound data (No in S15), the voice recognizing section 214 returns the process to step S11.

Meanwhile, if it is determined that the execution instruction is contained in the denoised sound data (Yes in S15), the voice recognizing section 214 inputs the determined execution instruction to the operation reception section 223.

The operation reception section 223 outputs the execution instruction determined by the voice recognizing section 214 to the job control section 222.

Based on the execution instruction input from the operation reception section 223, the job control section 222 executes the job (S16), and returns the process to step S11.

### <Denoising Process>

FIG. 6 is explanatory views showing an example of the procedure for eliminating the noise from the sound data. A Y-axis and an X-axis of each graph of FIG. 6 denote a sound intensity [dB], and sound frequency [f], respectively.

As described above, the denoising section 212 according to the embodiment eliminates the noise from the sound data using the noise pattern data. As the denoising process, for example, it is possible to use the spectrum subtraction method as generally known algorithm for denoising in the frequency region.

The graph (1) as shown in FIG. 6 represents a frequency distribution 301 of the sound data having the operation sound (noise) mixed with the user's voice. The frequency distribution 301 indicates the spectrum of the sound data having the operation sound (noise) mixed with the user's voice.

The graph (2) as shown in FIG. 6 represents a frequency distribution 302 of the noise pattern corresponding to the operation sound (noise). In other words, the frequency distribution 302 indicates the spectrum of the noise pattern.

The graph (3) as shown in FIG. 6 represents a frequency distribution 303 of the denoised sound data. The frequency distribution 303 indicates the spectrum of the denoised sound data. The use of the spectrum subtraction method allows the denoising section 212 to subtract the frequency distribution 302 from the frequency distribution 301 to extract the frequency distribution 303.

The voice recognizing section 214 may be configured to execute the voice recognition from the frequency component derived from the frequency distribution 303, or execute the voice recognition from the converted time-series data.

Various kinds of improved algorithms have been proposed as the spectrum subtraction method. The denoising section 212 may be configured to use the improved algorithm.

### <Summary>

Upon reception of an input of the voice during execution of the job, the above-described image forming apparatus 1 according to the embodiment allows the denoising section 212 to eliminate the noise pattern data from the input sound data. The voice recognizing section 214 executes the voice recognition based on the sound data having the noise eliminated (denoised sound data). If there are the operation pattern data corresponding to the execution instruction, which match the denoised sound data, the voice recognizing section 214 outputs the execution instruction of the job corresponding to the matched operation pattern data to the operation reception section 223. The operation reception section 223 inputs the execution instruction of the job received from the voice recognizing section 214 to the job control section 222. Then the job control section 222 executes the job based on the execution instruction.

Accordingly, in the environment in which the job under execution is generating the operation sound, the image forming apparatus 1 is allowed to recognize the voice job execution instruction.

If there are remaining job to be executed, and the job to be newly executed when the execution state of the job under execution has been changed, the noise pattern determination section 221 acquires the job information from the job control section 222. Based on the job information, the noise pattern determination section 221 newly generates the noise pattern data corresponding to the operation sound generated by the job to be executed after the change in the job execution state. The resultant data are stored in the noise pattern storage section 211.

The denoising section 212 is capable of eliminating interference sounds of multiple jobs to be executed in parallel, and the noise constituting abnormal sound caused by jamming of the passing sheet, while having the quality and volume of sound sharply changed as well as the noise caused by the operation sound generated in accordance with the type of job to be executed. The image forming apparatus 1 is capable of accurately recognizing the voice execution instruction in various circumstances where the steady noise owing to the job under execution, and the sharply changing noise without changing the operation in association with execution of the job.

### Modified Example

The microphone 201 of the image forming apparatus 1 according to the embodiment is built in the operation display section 70 as shown in FIG. 1. The microphone may be disposed in the device or the like adjacent to the image forming apparatus 1. The microphone 201 may be built in the image forming apparatus 1.

FIG. 2 illustrates connection of the voice input section 150 and the voice processing section 160 to the main controller 100 via the interface. The communication among the voice input section 150, the voice processing section 160, and the main controller 100 may be established via the network such as LAN (Local Area Network) and WAN (Wide Area Network). In this case, the voice input section 150 and the voice processing section 160 may be formed as devices disposed adjacent to the image forming apparatus 1.

Referring to the drawing, the voice processing section 160 is connected to the main controller 100 via the interface. The main controller 100 may be configured to include all or some of functions of the voice processing section 160.

The voice recognizing device may be configured by integrating the voice input section 150 and the voice processing section 160.

It is to be clearly understood that the present invention includes various applications and modifications without being limited to the above-described embodiment so long as they do not deviate from the scope of the present invention.

For example, the embodiment is described with respect to structures of the apparatus and the system in detail for readily understanding of the present invention which is not necessarily limited to the one equipped with all structures as described above. It is possible to replace a part of the structure of one embodiment with the structure of another embodiment. The one embodiment may be provided with an additional structure of another embodiment. It is further possible to add, remove, and replace the other structure to, from and with a part of the structure of the respective embodiments.

The control lines and information lines are shown as being necessary for convenience of explanation, and do not necessarily cover all the control lines and information lines of the product. Actually, it may be considered that substantially all the constituting components are mutually connected with one another.

### DESCRIPTION OF REFERENCE SIGNS

1 image forming apparatus
201 voice input section
212 denoising section
214 voice recognizing section
221 noise pattern determination section
222 job control section

What is claimed is:

1. An image forming apparatus comprising:
a control section that executes an input job;
a noise pattern determination section that determines a noise pattern corresponding to an operation sound generated in the image forming apparatus based on an execution state of the job to be executed by the control section;
a denoising section that eliminates a noise corresponding to the noise pattern from sound data to be input from an input section for collecting sounds based on the noise pattern data determined by the noise pattern determination section in accordance with a type of the job under execution by the control section; and
a voice recognizing section that recognizes an execution instruction of the job from the sound data having the noise eliminated.

2. The image forming apparatus according to claim 1, wherein:
the noise pattern determination section newly generates the noise pattern data by combining the noise pattern data to be determined from a plurality of jobs of different types to be executed in parallel by the control section; and
the denoising section eliminates the noise corresponding to the newly generated noise pattern from the sound data based on the newly generated noise pattern data.

3. The image forming apparatus according to claim 1, wherein the noise pattern determination section generates the noise pattern data based on a change that occurs in an execution state of the job under execution by the control section.

4. The image forming apparatus according to claim 1, further comprising a storage section that stores the noise pattern data, wherein:
the noise pattern determination section stores the generated noise pattern data in the storage section; and
the denoising section acquires the noise pattern data determined by the noise pattern determination section from the storage section in accordance with the type of the job under execution by the control section.

5. The image forming apparatus according to claim 4, wherein the execution state of the job is changed at any one of timings when: the execution of the job is instructed; another job is executed in the middle of the process for executing the job in parallel; one of the multiple jobs executed in parallel is terminated; all the jobs are terminated; abnormality occurs in the job under execution; and the abnormality is eliminated.

6. The image forming apparatus according to claim 1, wherein the input section converts sounds collected at a position where the input section is disposed into the sound data, and outputs the sound data to the denoising section.

7. A voice recognizing device comprising:
an input section that converts sounds collected at a position where the input section is disposed; and
a voice processing section that recognizes an execution instruction of a job to be executed by an image forming apparatus from the sound data, wherein:
the voice processing section includes:
a storage section that stores noise pattern data corresponding to an operation sound of the image forming apparatus, generated in accordance with an execution state of the job;
a denoising section that eliminates a noise corresponding to the noise pattern from the sound data input by the input section for collecting the sounds based on the noise pattern data determined by a noise pattern determination section of the image forming apparatus in accordance with a type of the job under execution by a control section of the image forming apparatus; and
a voice recognizing section that recognizes the execution instruction of the job from the sound data having the noise eliminated.

8. A non-transitory recording medium storing a computer readable program, wherein the program allows a computer to perform:
execution of an input job;
determination of a noise pattern corresponding to an operation sound generated in an image forming apparatus based on an execution state of the job;
elimination of a noise corresponding to the noise pattern from sound data to be input by an input section for collecting sounds based on the noise pattern data determined in accordance with a type of the job under execution; and
recognition of an execution instruction of the job from the sound data having the noise eliminated.
